(19) United States
(12) Patent Application Publication
(10) Pub. No.: US 2006/0243792 A1
(43) Pub. Date: Nov. 2, 2006

(54) Stored-value card for variable printing and methods of using and making the same

(76) Inventors: Peter S. Morello, Stuart, FL (US); Eitan C. Zeira, Hollis, NH (US); Richard Selah, Newtown, PA (US); Laura Ellen Matz, Holliston, MA (US)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(21) Appl. No.: 11/397,408

(22) Filed: Apr. 4, 2006

Related U.S. Application Data
(60) Provisional application No. 60/667,987, filed on Apr. 4, 2005.

(51) Int. Cl. G06K 5/00; G06K 19/00

(52) U.S. Cl. 235/380; 235/487

(57) ABSTRACT

A stored-value card is provided which can be customized or imprinted with customer-friendly information at a point-of-sale. The stored-value card is made of a flexible material and includes a machine-readable data storage medium. The stored-value card also has at least one ink-receptive printable region which allows variable printing. One or more security features may be included on the stored-value card. Methods of using and making the stored-value card are provided.

This application claims the benefit of the filing date of U.S. Provisional Patent Application Ser. No. 60/667,987, filed on Apr. 4, 2005, the entire disclosure of which is incorporated by reference herein for all purposes.

### TECHNICAL FIELD

The invention generally relates to stored-value cards and methods of using and making them. More particularly, the invention relates to stored-value cards that allow variable printing and display on a card surface. The variable printing feature provides information otherwise inaccessible to a card bearer while providing flexibility and increased security to the card issuer.

### BACKGROUND

Stored-value card systems are used by the retail industry to allow customers to give a gift card of a particular value rather than multiple gift certificates and retailers to track the use of the given value. When a customer requests a refund for a previous purchase, retailers also often issue store credit in the form of a stored-value card to avoid confusion with other transaction receipts. Stored-value cards are typically purchased or issued in predefined value increments. The card provides a customer with store credit that can be used at one or more retail stores. Each of the cards has an identification number printed or magnetically stored on it, which is often linked to a record in a database in a central host maintained by the card issuer. This record also stores the predefined value (cash equivalent or credit) of the card as well as other relevant information. When a card is issued to a customer at a retail location, the corresponding record in the database is activated, thus allowing the card to be used immediately by the customer. If the customer uses only part of the total (or remaining) value of the card for a purchase, the corresponding record in the database is updated as to the current value of the card, with the remaining value able to be applied to future purchases. When the value of the card is exhausted, the card becomes inactive or invalid and the card is discarded.

The state-of-the-art stored-value card systems have disadvantages. The cards typically have no human-readable indicators on them as to their remaining value. This creates problems both for the consumer and for the retailer. The consumer cannot readily tell how much cash value remains on the card without having to log onto a web site, call a toll-free number, or ask at a retail store. In addition, consumers can be deceived into buying invalid gift cards bought second-hand, e.g., over the internet, because the value of the card cannot be verified. The retailer often needs to create a web site to permit consumers to ascertain the remaining value on their cards. Such a web site is expensive to maintain and is vulnerable to fraud. A would-be offender can log onto the web site, search its database to identify cards with value, and then either use the identification numbers associated with these cards to make unauthorized purchases over the internet, or use a card with one of these identification numbers recorded on its magnetic stripe to make unauthorized purchases at the store.

Another disadvantage with current stored-value card systems is the lack of means to indicate an activation and/or expiration date of a card at the time of purchase. Retailers often desire to enforce an expiration date on gift cards so that the associated store credit can be cleared from its ledger on a definite date if not used beforehand. However, with the current stored-value card systems, consumers cannot readily find out from the face of a card whether the card has any expiration date. To protect consumers, many states are enacting laws requiring any expiration date to be prominently displayed on the card. Because the expiration date of a stored-value card typically will be calculated from the date of its purchase or issuance, being able to provide an expiration date on a gift card at the point-of-sale is highly desirable.

In addition, most currently available gift cards have preset denominations, e.g., $10, $25, and $50, that are established at the time of manufacture and printing of the cards. This practice requires the retailer to maintain an inventory of many different cards, which increases costs and the opportunity for theft. Accordingly, a retailer who has the flexibility for point-of-sale card preparation can reduce its inventory and associated issues.

### SUMMARY OF THE INVENTION

The invention addresses the above needs by providing stored-value cards that allow variable printing using existing equipment at various points-of-sale, e.g., printers currently being used to print receipts. The invention also provides methods that allow the printing of card-specific information on the face of a stored-value card at a point-of-sale. Accordingly, the stored-value card contains visible indications that keep a card bearer (consumer) informed as to the expiration date and/or the remaining value of the card at any time. The visible indications can also serve to verify that the card has value and is not void or expired. Further, printing information on a stored-value card at the time of purchase instead of at the time of manufacture reduces inventory for a retailer.

In one aspect, the invention provides a card for storing value. It should be understood that value as used herein refers to cash equivalent, credit, and the like. Value can also refer to tangible items such as specific store merchandise or to intangible items such as an admission pass to an event. For example, the stored-value card could be used for an entertainment event where the card holder is able to use his/her card for entry into 4 events and obtain 2 meals and 4 beverages. The stored-value card could also be used as a loyalty card whereby the use of the card is tracked and after a particular amount of use is achieved, the card holder receives “free” merchandise. For example, in the case of a grocery store, after a certain amount of purchases are made, the card can be used for a free turkey on Thanksgiving Day. Therefore, value refers to anything on which a retailer places worth.

The card generally includes a flexible substrate, a machine-readable data storage medium, and at least one printable region. The flexible substrate includes a front face and a rear face, on one of which the at least one printable region is supported. The printable region(s) may include a receptive coating for ink, in which case the receptive coating and the ink are adapted to be tamper evident. The printable region(s) may be imprinted with at least a portion of the data stored on the machine-readable data storage medium in human-readable form.

In some embodiments, the flexible substrate includes paper, polypropylene, polyethylene terephthalate, and combinations thereof. The machine-readable data storage medium may include at least one of a magnetic stripe, a bar code, a radio-frequency identification (RFID) chip, an integrated circuit (IC) chip, and an optical identification means. The flexible substrate and the machine-readable data storage medium may be adapted to be transported through a printer without causing physical damage to the flexible substrate or a loss of data stored on the machine-readable data storage medium.

The printable region(s) may be imprinted by any conventional printers or plotters. For example, the printable region(s) may be imprinted with a marking made by a dot matrix printer, an inkjet printer, a direct thermal printer, or a thermal transfer printer. The marking may include one or more colors. Preferably, a multi-color ink ribbon, such as a dual-color ink ribbon, is used to mark the printable region(s) to provide enhanced security. Other security features that may be included on the card include, but are not limited to, a radiofrequency tag, photoluminescent compounds, and combinations thereof.

The machine-readable data storage medium typically contains at least one type of card-specific data while also containing other non-card-specific or generic information relevant to the retailer, e.g., name of retailer, store location, trade or service marks, and the like. Non-limiting examples of card-specific data include a unique identification number, an activation date, an expiration date, an initial value, and a remaining value. The printable region(s) on the card may be imprinted with at least one type of such card-specific data, i.e., one printable region may contain multiple types of card-specific data. The printable regions may also contain non-card-specific information.

The unavailability of card-specific data on the face of the card often discourages consumers from purchasing stored-value cards. To solve this problem, the printable region(s) on the card of the invention allow variable printing which can take place at various points-of-sale, e.g., at initial purchase of the card and after a transaction. For example, the card may include a printable region that can be incrementally marked by ink to reflect the value of the card as it is depleted and/or the amount of time remaining until the card expires. For convenience, the printable region may be shaped like a meter, for example in the form of a bar chart, a pie graph, or any other graphic renditions that can provide a visual estimate of the card-specific data described above. Alternatively, the exact remaining value and/or the expiration date may be imprinted on the printable region at a point-of-sale.

In another aspect, the invention provides a method for providing information to a bearer of a stored-value card. The method generally includes the steps of providing a stored-value card including at least one printable region having a receptive coating adapted to receive a marking, and imprinting the printable region(s) with an ink to create a marking at a point-of-sale where the stored-value card is used to complete (“pay for”) a transaction. The marking may be indicative of the exact or approximate remaining value of the stored-value card. The step of imprinting may include printing with a dot matrix printer, an inkjet printer, a direct thermal printer, a thermal transfer printer, or any conventional printers or plotters. The receptive coating and the ink may be adapted to be tamper evident. The stored-value card may include a machine-readable data storage medium, and the method may include the step of storing a value of the stored-value card on the machine-readable data storage medium or a remote machine-readable data storage medium, e.g., a remote database in a central host. The stored-value card may be composed of a flexible substrate adapted for the step of imprinting with a printer.

A third aspect of the invention provides a method for customizing a stored-value card at a point-of-sale. The method generally includes the steps of (i) providing a stored-value card including a machine-readable data storage medium, a first printable region and a second printable region, where both the first printable region and the second printable region include a receptive coating adapted to receive a marking; (ii) imprinting at a first point-of-sale the first printable region with a marking to indicate the initial value of the stored-value card; and (iii) storing the initial value of the stored-value card on the machine-readable data storage medium or a remote machine-readable storage medium. The method may include imprinting at the first point-of-sale the first printable region or the second printable region with another marking to indicate the expiration date of the stored-value card. The stored-value card may include a third printable region, and the method may include imprinting at a second point-of-sale the third printable region with another marking, where the marking is indicative of the exact or approximate remaining value of the stored-value card. It should be understood that for this aspect as well as the other aspects of the invention, the first, second, and higher-order printable regions may overlap and/or be contained within each other. Each of the printable regions also can be distinct, i.e., non-overlapping.

Methods of making the stored-value cards described above are within the scope of the invention.

The foregoing, and other features and advantages of the invention as well as the invention itself, will be more fully understood from the following figure, description, and claims.

### BRIEF DESCRIPTION OF THE DRAWING

FIG. 1 is a depiction of an embodiment of a stored-value card of the invention.

### DETAILED DESCRIPTION

Throughout the description, where compositions are described as having, including, or comprising specific components, or where processes are described as having, including, or comprising specific process steps, it is contemplated that compositions of the present invention also consist essentially of, or consist of, the recited components, and that the processes of the present invention also consist essentially of, or consist of, the recited processing steps. It should be understood that the order of steps or order for performing certain actions is immaterial so long as the invention remains operable. Moreover, two or more steps or actions may be conducted simultaneously.

In a first aspect, the present invention provides a card for storing value. The card generally includes a flexible substrate, a machine-readable data storage medium, and at least one printable region. Each of these components will be described in detail below.

The flexible substrate includes a front face and a rear face. Suitable substrates include, but are not limited to, paper, polypropylene, polyethylene terephthalate, e.g., Mylar® (Dupont Teijin Films, Hopewell, Va.), and combinations thereof. Preferred substrates offer both flexibility and sturdiness such that the card can withstand normal “wear and tear” during its life, e.g., in and out of a wallet, and not sustain any physical damage when being transported through a printer. In one embodiment, the flexible substrate may include a piece of paper card stock laminated on one surface with a piece of Mylar® film.

The machine-readable data storage medium may include at least one of a magnetic stripe, a bar code, a radio-frequency identification (RFID) chip, an integrated circuit (IC) chip, and an optical identification means. In preferred embodiments, the machine-readable data storage medium is adapted to be transported through a printer without suffering any loss of data. The machine-readable data storage medium may be used to store non-card-specific data and card-specific data including, but are not limited to, a unique identification number, an initial value, a remaining value, an activation date, and an expiration date. In some embodiments, most of the card-specific data may be stored on a remote machine-readable data storage medium, e.g., a database in a central host, and the machine-readable data storage medium may contain little data other than the minimum information, e.g., an identification number required to access a record in the remote database.

One or more printable region(s) may be supported on the front face and/or the back face of the card. The printable region(s) generally include a receptive coating for ink, in which case the receptive coating and the ink may be adapted to be tamper evident. As used herein, the term “tamper evident” refers to a property of the card which creates a visible indication, e.g., an ink smudge, after an attempt to alter the information on the card, e.g., the unauthorized removal of a marking created by the ink. In preferred embodiments, the ink associates with and/or reacts with the receptive coating to become tamper evident. However, other means for creating tamper evident cards are known.

The printable region(s) may be imprinted in human-readable form with at least a portion of the data stored on either the machine-readable data storage medium on the card or a remote machine-readable data storage medium. In preferred embodiments, the printable region(s) may be imprinted with at least one type of card-specific data including the activation date, the expiration date, the initial value, and the remaining value. The printable regions also can contain other information as markings.

Card-specific data imprinted on the printable region(s) may be an estimated value or an exact value. A visual image that provides an estimate value of the card-specific data is often sufficient for most consumers. For ease of reference, the printable region may be any kind of graphic rendition that can be incrementally marked or filled to indicate an estimated value of one or more types of card-specific data. For example, the graphic rendition may include, but is not limited to, a meter, a bar graph, or a pie chart, that can be incrementally filled to reflect the value of the card as it is depleted and/or the amount of time remaining until the card expires. The markings used to fill the graphic rendition can be solid or non-solid such as “X”'s or circles. In the case of exact value markings, the specific dollar value or merchandise can be imprinted. In certain embodiments, when a new exact value is printed, the most recent card value is blackened out or made unreadable to avoid confusion for the card bearer.

The type of receptive coating used on a printable region depends on the printing method employed at the intended points-of-sale. For example, some point-of-sale printers use direct thermal media to print. In this case, the receptive coating may be a coating that darkens when exposed to heat. Other points-of-sale may use dot matrix printers, thermal transfer printers, or inkjet printers. In either of the first two cases, ink is transferred from an ink ribbon to a substrate. For dot matrix printers, the transfer is carried out by mechanical means. In thermal transfer printers, the print head melts the ink to create a marking. In the case of an inkjet printer, ink is deposited by spraying droplets of an ink solution onto the substrate. The receptive coating for any of these cases will be a coating that is receptive to the specific type of ink used in conjunction with the printer. For added security, the printable region(s) may be imprinted with a multi-color marking, e.g., with the use of a dual- or multi-color ink ribbon. Other security features that may be used along with the invention include, but are not limited to, a radiofrequency (RF) tag, such as an RF fiber or RF chip, a photoluminescent compound, and any combinations thereof. Such security features often are associated with the substrate of the card, e.g., embedded within the substrate or another coating thereon.

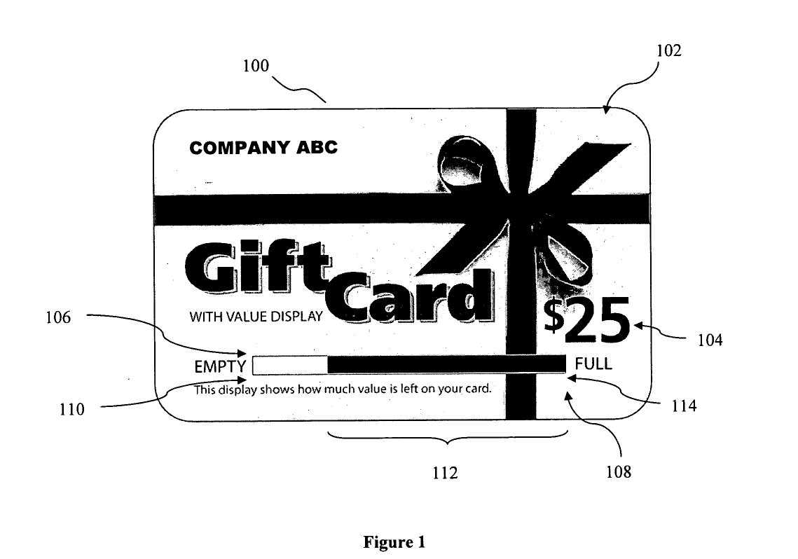

FIG. 1 illustrates an embodiment of the invention. Referring to FIG. 1, a stored value card 100 includes a flexible substrate 102, a machine-readable data storage medium (not shown because located on the reverse side of the card), and printable regions 104 and 106. The printable region 104 is imprinted with the initial value of the card, i.e., twenty-five dollars. The printable region 106 represents a bar chart for indicating the remaining value of the card. A first end 108 of the printable region 106 is labeled ‘FULL,’ while a second end 110 of the printable region 106 is labeled ‘EMPTY.’ A first region 112 has been imprinted with markings 114 to approximate the amount of money that has been spent. A consumer can readily determine from the markings that the remaining value of the card is about five dollars.

In a second aspect, the invention provides a method for providing information to a bearer of a stored-value card. Particular uses and advantages of such a method have been previously described. The method generally includes the steps of providing a stored-value card including at least one printable region having a receptive coating adapted to receive a marking, and imprinting the printable region(s) with an ink to create a marking at a point-of-sale where the stored-value card is used to pay for a transaction. The marking may be indicative of an exact or approximate remaining value of the stored-value card. Alternatively or complementarily in certain embodiments, the markings may be indicative of the exact or approximate time remaining until the expiration date of the stored-value card. The step of imprinting may include printing with a dot matrix printer, an inkjet printer, a direct thermal printer, a thermal transfer printer, or any other conventional printers or plotters. The receptive coating and the ink may be adapted to be tamper evident. The stored-value card may include a machine-readable data storage medium, and the method may include the step of storing a value of the stored-value card on the machine-readable data storage medium or a remote machine-readable data storage medium. The stored-value card may be composed of a flexible substrate adapted for the step of imprinting with a printer. FIG. 1 depicts a stored-value card that can be used in the practice of this method.

In a third aspect, the invention provides a method for customizing a stored-value card at a point-of-sale. Particular uses and advantages of practicing such a method have been previously described. The method generally includes the steps of providing a stored-value card including a machine-readable data storage medium, a first printable region and a second printable region, where both the first printable region and the second printable region include a receptive coating adapted to receive a marking; imprinting at a first point-of-sale the first printable region with a marking to indicate the initial value of the stored-value card, and storing the initial value of the stored-value card on the machine-readable data storage medium or a remote machine-readable storage medium. The method may include imprinting at the first point-of-sale the first printable region or the second printable region with another marking to indicate the expiration date of the stored-value card. The stored-value card may include a third printable region, and the method may include imprinting at a second point-of-sale the third printable region with another marking, where the marking is indicative of the exact or approximate remaining value of the stored-value card. The stored-value card may include more than three printable regions, and the first printable region, the second printable region, and the third printable region may be the same region, may overlap with each other, or may be distinct from one another. FIG. 1 depicts a stored-value card that can be used in such a method.

Methods of making the stored-value cards described above are within the knowledge of those skilled in the arts and are within the scope of the invention.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A card for storing value, the card comprising:
a flexible substrate, the flexible substrate comprising a front face and a rear face;
at least one printable region supported on one of the front and rear faces, the at least one printable region comprising a receptive coating for an ink, wherein the receptive coating and the ink are adapted to be tamper evident; and
a machine-readable data storage medium, wherein the at least one printable region is imprinted with at least a portion of the data stored on the machine-readable data storage medium in human-readable form.

2. The card of claim 1, wherein the flexible substrate is selected from the group consisting of paper, polypropylene, polyethylene terephthalate, and combinations thereof.

3. The card of claim 1, wherein the machine-readable data storage medium comprises at least one of a magnetic stripe, a bar code, a radio-frequency identification (RFID) chip, an integrated circuit (IC) chip, and an optical identification means.

4. The card of claim 1, wherein the machine-readable data storage medium contains at least one type of card-specific data selected from the group consisting of an identification number, an activation date of the card, an expiration date of the card, an initial value of the card, and a remaining value of the card.

5. The card of claim 1, wherein the at least one printable region is imprinted with at least one type of card-specific data selected from the group consisting of an activation date of the card, an expiration date of the card, an initial value of the card, and a remaining value of the card.

6. The card of claim 1, wherein the at least one printable region is in the shape of a bar chart, a meter, or a pie graph that is incrementally filled to represent depletion of a value of the card or time remaining until an expiration date of the card.

7. The card of claim 1, wherein the at least one printable region is imprinted with a marking made by a dot matrix printer, an inkjet printer, a direct thermal printer, or a thermal transfer printer.

8. The card of claim 7, wherein the marking comprises at least two colors.

9. The card of claim 1, wherein the flexible substrate and the machine-readable data storage medium is adapted to be transported through a printer without causing physical damage to the flexible substrate or a loss of data stored on the machine-readable data storage medium.

10. The card of claim 1, wherein the card comprises a security feature.

11. The card of claim 10, wherein the security feature comprises a radiofrequency tag, a photoluminescent compound, or combinations thereof.

12. A method of making the card of claim 1.

13. A method for providing information to a bearer of a stored-value card, the method comprising the steps of:
providing a stored-value card comprising at least one printable region, the at least one printable region comprising a receptive coating adapted to receive a marking;
imprinting the at least one printable region with an ink to create a marking at a point-of-sale where the stored-value card is used to pay for a transaction, wherein the marking is indicative of an exact or approximate remaining value of the stored-value card.

14. The method of claim 13, wherein the step of imprinting comprises printing with a dot matrix printer, an inkjet printer, a direct thermal printer, or a thermal transfer printer.

15. The method of claim 13, wherein the receptive coating and the ink are adapted to be tamper evident.

16. The method of claim 13, wherein the stored-value card comprises a machine-readable data storage medium; and the method comprises the step of storing a value of the stored-value card on the machine-readable data storage medium or a remote machine-readable data storage medium.

17. The method of claim 13, wherein the stored-value card comprises a flexible substrate adapted for the step of imprinting with a printer.

18. A method for customizing a stored-value card at a point-of-sale, the method comprising the steps of:
providing a stored-value card comprising a first printable region, a second printable region, and a machine-readable data storage medium, wherein the first printable region and the second printable region comprise a receptive coating adapted to receive a marking;
imprinting at a first point-of-sale the first printable region with a first marking to indicate a value of the stored-value card; and
storing the value of the stored-value card on the machine-readable data storage medium or a remote machine-readable data storage medium.

19. The method of claim 18 comprising the step of:
imprinting at the first point-of-sale the second printable region with a second marking to indicate an expiration date of the stored-value card.

20. The method of claim 19, wherein the stored-value card further comprises a third printable region, the method comprising the step of:
imprinting at a second point-of-sale the third printable region with a third marking to indicate an exact or approximate remaining value of the stored-value card.
